(19) United States
(12) Patent Application Publication
(10) Pub. No.: US 2010/0130124 A1
(43) Pub. Date: May 27, 2010

(54) METHOD AND APPARATUS FOR USING A REMOTE DISTRIBUTED POWER LOCOMOTIVE AS A REPEATER IN THE COMMUNICATIONS LINK BETWEEN A HEAD-OF-TRAIN DEVICE AND AN END-OF-TRAIN DEVICE

(75) Inventors: David Carroll Teeter, Melbourne, FL (US); Eugene Smith, Satellite Beach, FL (US); James Glen Corry, Melbourne, FL (US); Robert James Foy, Melbourne, FL (US); James P. Schmitz, Melbourne, FL (US)

Correspondence Address: BEUSSE WOLTER SANKS MORA & MAIRE, P.A., 390 NORTH ORANGE AVENUE, SUITE 2500, ORLANDO, FL, 32801, US

(73) Assignee: GENERAL ELECTRIC COMPANY, Fairfield, CT (US)

(21) Appl. No.: 12/276,378

(22) Filed: Nov. 23, 2008

(51) Int. Cl. H04B 7/14

(52) U.S. Cl. 455/15

(57) ABSTRACT

Communicating messages between an HOT device (48L) in a lead locomotive (14) and an EOT device (40) at an end-of-train position. The method comprises tuning a DP transceiver (28L) onboard a remote locomotive (12A) to an HOT/EOT communications channel frequency, transmitting a message from the EOT device (40) intended for the HOT device (48L) or transmitting a message from the HOT device (48L) intended for the EOT device (40), and receiving the message at the DP transceiver (28L). If the message was transmitted from EOT device (40), transmitting the message from the DP transceiver (28L) to HOT device (48L) and receiving and executing the message at the HOT device (48L). If the message was transmitted from the HOT device (48L), transmitting the message from the DP transceiver (28L) to the EOT device (40) and receiving and executing the message at the EOT device (40).

### FIELD OF THE INVENTION

This invention relates generally to railroad train communications systems and particularly to a communications system for use with a railroad train having a head-of-train and an end-of-train communications device.

### BACKGROUND OF THE INVENTION

Under operator control, a railroad locomotive supplies motive power (traction) to move a train and applies brakes on the locomotive and/or on train railcars to slow or stop the train. The motive power is supplied by electric traction motors responsive to an AC or DC signal generated by the locomotive engine.

The railroad train comprises three separate brake systems. An air brake system comprises a fluid-carrying (typically the fluid comprises air) brake pipe that extends a length of the train and a railcar brake system. Wheel brakes are applied or released at each locomotive and each railcar in response to a fluid pressure in the brake pipe. An operator-controlled brake handle controls the brake pipe pressure, venting the brake pipe to reduce the pressure to signal the locomotives and railcars to apply the brakes or charging the brake pipe to increase the pressure to signal the locomotive and railcars to release the brakes. For safe train operation, when pressure in the brake pipe falls below a threshold value the brakes default to an applied condition.

Each locomotive also comprises an independent pneumatic brake system controlled by the operator to apply or release only the locomotive brakes. The system, which is coupled to the air brake system, applies the locomotive brakes by increasing the pressure in the locomotive brake cylinders and releases the locomotive brakes responsive to a decrease in the cylinder air pressure.

Finally, each locomotive is equipped with a dynamic brake system. Activation of the dynamic brakes reconfigures the locomotive's traction motors to operate as generators, with the inertia of the locomotive wheels supplying rotational energy to turn the generator rotor winding. Magnetic forces developed by generator action resist wheel rotation and thus create wheel-braking forces. The energy produced by the generator is dissipated as heat in a resistor grid in the locomotive and removed by one or more cooling blowers. Use of the dynamic brakes is indicated to slow the train when application of the locomotive independent brakes and/or the railcar air brakes may cause the locomotive or railcar wheels to overheat or when prolonged use may cause excessive wheel wear. For example, the dynamic brakes may be applied when the train is traversing a prolonged downgrade.

A train configured for distributed power (DP) operation comprises a lead locomotive at a head-end of the train, and one or more remote locomotives between the head-end and an end of the train. A DP train may also comprise one or more locomotives at the end of the train. The DP system further comprises a distributed power train control and communications system with a communications channel (e.g., a radio frequency (RF) or a wire-based communications channel) linking the lead and remote locomotives.

The DP system generates traction and brake commands responsive to operator-initiated (e.g., the operator in the lead locomotive) control of a lead locomotive traction controller (or throttle handle) or a lead locomotive brake controller (responsive to operation of an air brake handle, a dynamic brake handle or an independent brake handle). These traction or brake commands are transmitted to the remote locomotives over the DP communications channel. The receiving remote locomotives respond to the traction or brake (apply and release) commands to apply tractive effort or to apply/release the brakes and further advise the lead locomotive that the command was received and executed. For example, when the lead locomotive operator operates the lead-locomotive throttle controller to apply tractive effort at the lead locomotive, according to a selected throttle notch number, the DP system issues commands to each remote locomotive to apply the same tractive effort (e.g., the same notch number). Each remote locomotive replies to acknowledge execution of the command. The lead locomotive also issues status request messages and the remote locomotives respond with operational data. The lead and remote locomotives can also issue alarm messages.

In a railroad train without a DP system, when the lead locomotive operator operates the air brake handle, the pressure in the brake pipe increases or decreases and this pressure change propagates along the entire train until reaching an end-of-train (EOT) device on the last railcar. As each remote locomotive senses the pressure change, it too either vents or charges the brake pipe responsive to the sensed pressure change. Depending on train length, several seconds may elapse before the pressure reduction reaches the end of the train. Valuable time may be lost for an emergency brake application.

However in a DP train, the lead locomotive also transmits brake application messages (in the form of an RF signal) to each remote locomotive over the DP communications link. Responsive to the command, the brake pipe is vented at each remote locomotive to accelerate the application of the railcar brakes, since the remote locomotives receive the communications channel message before they sense the brake pipe pressure change. For an emergency brake application, venting the brake pipe at the lead and at the remote locomotives accelerates the brake pipe venting process and the application of the brakes at each railcar, especially for the railcars near the end of the train.

A brake release initiated at the lead locomotive is also communicated over the DP communications channel to the remote locomotives so that the brake pipe is concurrently recharged to its nominal pressure from all locomotives, thereby reducing brake pipe recharge time.

Prior to beginning operation, the locomotives of the DP train are linked to ensure that each communicates only with locomotives of the same train. During the linking process the locomotives exchange unique identification numbers. Each message sent during train operation includes the unique identification number of the sending locomotive and the number of the receiving locomotive. Before replying or executing the command embodied in a message, the receiving locomotive checks the identification information of the sending locomotive to determine a valid transmitted message and checks the identification information of the intended receiving locomotive to determine if it is the intended recipient.

In general, traction and braking messages sent over the distributed power communications system result in the application of more uniform tractive and braking forces to the railcars, as each locomotive can effect a brake application or release at the speed of communications channel signal rather than the slower speed of the pneumatic brake pipe pressure change that must propagate along the entire train. Distributed power train operation may therefore be preferable for long train consists to improve train handling, especially braking applications, and performance. Trains operating over mountainous terrain can realize benefits from DP operation.

The train further comprises a head-of-train (HOT) device in the head-end locomotive for bidirectionally communicating with the EOT device. An HOT/EOT radio communications channel is independent from the DP communications channel. The HOT device transmits status requests and commands to the EOT device over the HOT/EOT communications channel. For example, the HOT device commands a brake application, e.g., venting the brake pipe from the EOT device. The EOT device transmits status messages to the HOT device. For example, the EOT device monitors the brake pipe pressure at the end of the train and communicates the pressure to the head-of-train device. Although the DP communications system allows operation of longer trains, the HOT-EOT communications become more difficult as the train length increases.

### SUMMARY OF THE INVENTION

One embodiment of the invention relates to a method for communicating messages between an HOT device in a lead locomotive and an EOT device at an end-of-train position of a railroad train. The railroad train further comprises a remote locomotive between the lead locomotive and the EOT device. The method comprises: tuning a DP transceiver onboard the remote locomotive to a frequency of an HOT/EOT communications channel, transmitting a message from the EOT device intended for the HOT device or a message from the HOT device intended for the EOT device and receiving the message at the DP transceiver. If the message was transmitted from the EOT device, transmitting the message from the DP transceiver to the HOT device and receiving and executing the message at the HOT device. If the message was transmitted from the HOT device, transmitting the message from the DP transceiver to the EOT device and receiving and executing the message at the EOT device.

Advantageously, this embodiment of the invention solves the problem of problematic HOT/EOT communications by using the DP communications system to relay HOT and EOT messages between the HOT and the EOT devices.

### BRIEF DESCRIPTION OF THE DRAWINGS

The present invention can be more easily understood and the further advantages and uses thereof more readily apparent, when considered in view of the following detailed description when read in conjunction with the following figures. In accordance with common practice, the various described features are not drawn to scale, but are drawn to emphasize specific features relevant to the invention. Reference characters denote like elements throughout the figures and text.

FIG. 1 illustrates a distributed power train to which the teachings of the present invention can be applied.

FIG. 2 illustrates, in block diagram form, communication elements of the DP communications system and the HOT/EOT communications system.

FIGS. 3-6 illustrate flowcharts depicting processing steps according to various embodiments of the present invention.

FIG. 7 illustrates in block diagram form, communication elements of the DP communications system and the HOT/EOT communications system according to an embodiment of the invention.

FIG. 8 illustrates a flowchart depicting processing steps according to an embodiment of the invention.

### DETAILED DESCRIPTION OF THE INVENTION

Before describing in detail the particular method and apparatus for using a remote distributed power locomotive as a repeater in the communications link between a head-of-train device and an end-of-train device in accordance with aspects of the present invention, it should be observed that the present invention resides primarily in a novel combination of hardware and software elements related to said method and apparatus. Accordingly, the hardware and software elements have been represented by conventional elements in the drawings, showing only those specific details that are pertinent to the present invention, so as not to obscure the disclosure with structural details that will be readily apparent to those skilled in the art having the benefit of the description herein.

The following embodiments are not intended to define limits as to the structures or methods of the invention, but only to provide exemplary constructions. The embodiments are permissive rather than mandatory and illustrative rather than exhaustive.

An example of a DP train control and communications systems is the LOCOTROL® distributed power communications system available from the General Electric Company of Fairfield, Conn. The LOCOTROL® distributed power system comprises a radio frequency link (channel) and receiving and transmitting devices at the lead and the remote locomotives.

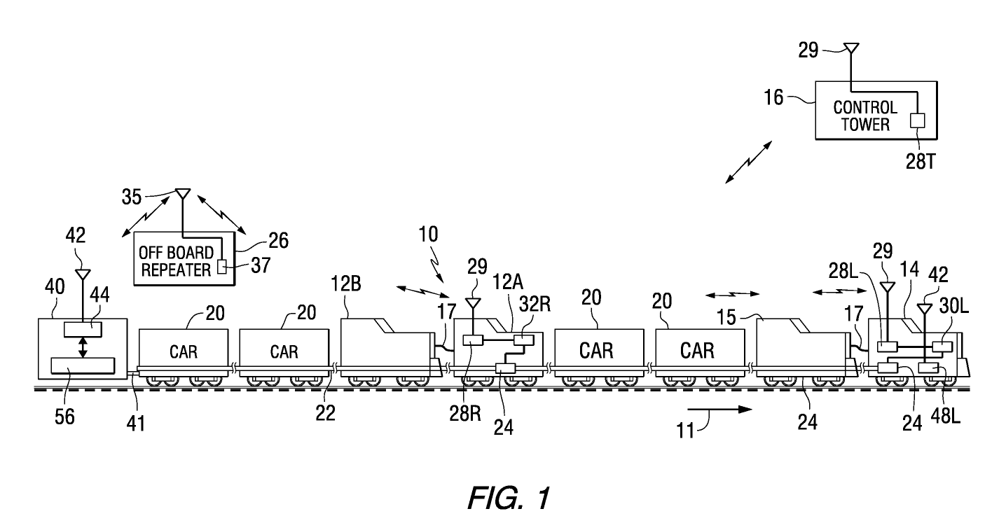

FIG. 1 schematically illustrates an exemplary distributed power train 10, traveling in a direction indicated by an arrowhead 11. A remote locomotive 12A (also referred to as a remote unit) is controlled by messages transmitted from either a lead locomotive 14 (also referred to as a lead locomotive) or from a control tower 16. Control tower commands are issued by a dispatcher either directly to the remote locomotive 12A or to the remote locomotive 12A via the lead locomotive 14.

A trailing locomotive 15 coupled to the lead locomotive 14 is controlled by the lead locomotive 14 via control signals carried on an MU (multiple locomotive) line 17 connecting the two units. Also, a trailing remote locomotive 12B coupled to the remote locomotive 12A is controlled by the remote locomotive 12A via control signals carried on the MU line 17.

Each of the locomotives 14 and 12A and the control tower 16 comprises a DP transceiver 28L, 28R, 28T (also referred to as a DP radio) and a DP antenna 29 for receiving and transmitting the DP communication messages. The DP transceivers are referred to by suffixed reference numerals 28L, 28R and 28T indicating location in the lead locomotive, remote locomotive and the control tower, respectively.

The DP commands are typically generated in a lead station 30L in the lead unit 14 responsive to operator control of the motive power and braking controls in the lead locomotive 14, as described above. The remote locomotive 12A also comprises a remote station 32R for processing messages from the lead locomotive 14 and for issuing reply messages and commands.

The distributed power train 10 further comprises a plurality of railcars 20 interposed between the locomotives illustrated in FIG. 1 and connected to a brake pipe 22. The railcars 20 are provided with an air brake system (certain components of which are not shown in FIG. 1) that applies the railcar air brakes in response to a pressure drop in the brake pipe 22 and releases the air brakes in response to a pressure increase in the brake pipe 22. The brake pipe 22 runs the length of the train for conveying the air pressure changes specified by air brake controllers 24 in the locomotives 14 and 12A.

To further improve system reliability, one embodiment of a distributed power train communications system comprises an off-board repeater 26 for receiving messages sent from the lead locomotive 14 and repeating (retransmitting) the message for receiving by the remote locomotive 12A. This embodiment may be practiced along a length of track that passes through a tunnel, for example. In such an embodiment the off-board repeater 26 comprises an antenna 35 (e.g., a leaky coaxial cable mounted along the tunnel length) and a remote station 37 for receiving and retransmitting lead messages.

The DP train 10 further comprises an EOT (end-of-train) device 40 conventionally connected to a coupler 41 of the last railcar 20. The EOT device 40 includes an antenna 42, an EOT transceiver 44 (also referred to as an EOT radio) for sending signals to and receiving signals from an HOT (head of train) device 48L in the lead locomotive 14, and monitoring and control equipment 56.

The HOT device 48L (in the lead locomotive 14) comprises an antenna 42, an HOT transceiver and monitoring and control equipment (not shown separately). Typically, the EOT and HOT transceivers operate over a different communications channel (frequency) than the radios of the DP communications system and use communications equipment independent from the DP communications system, as depicted.

The HOT and EOT devices communicate bidirectionally and regularly during normal train operation. Typically, the EOT transceiver/device transmits status messages both periodically (such as once per minute) and when a significant event is observed at the end of the train, such as a substantial brake pipe pressure change or loss of power. The EOT transceiver transmits blindly without reply acknowledgements from the HOT device/transceiver 48L in the lead unit 14.

If after a predetermined time interval from receipt of a prior EOT message, the HOT device 48L does not receive the next scheduled EOT status message, a communications loss is noted and the lead locomotive operator is alerted. The lead operator can conduct a communications system check by commanding the HOT device to send a status request message to the EOT device. A correctly operating EOT device responds to the status request immediately.

To ensure brake pipe integrity and proper operation of the brakes, the air pressure in the brake pipe is monitored at the EOT device 40 and at the HOT device 48L. The EOT device also typically monitors battery condition (e.g., the battery that powers an EOT warning light and the EOT communications equipment), warning light operation, and train movement. The monitored information is transmitted to the HOT device 48L by the battery powered transceiver 44 operating over an ultra-high frequency (UHF) or a very-high frequency (VHF) radio channel. The EOT device 40 can also signal the lead locomotive operator, via an emergency message to the HOT device 48L, that an emergency condition exists at the end of the train, such as a sudden loss of air pressure, air pressure below a predetermined value, or loss of power.

Each EOT and HOT device bears a unique identification number assigned at the time of manufacture. The HOT and EOT devices are initially linked prior to train movement through a communication linking process. The link is initialized by a multi-stage communication “handshake” designed to ensure subsequent reliable and exclusive communication between the HOT and EOT devices of the same train. During the linking process the HOT and EOT devices exchange their identification information. The identification information is stored in both the HOT and EOT device and subsequent HOT/EOT messages include the identification information of the receiving unit. The receiving unit responds or executes only the messages that include its identification information.

The DP communications system conventionally comprises redundant RF transceivers at the lead and each remote locomotive, with typically only one transceiver in operation at any time for DP communications. Advantageously, the frequencies used by the DP communications system and the HOT/EOT communications system lie within the same frequency band. Ideally, a railroad would like to increase the length of its operating trains to limit costs and satisfy customer delivery requirements, but the ability to close a communications link between the HOT and EOT devices imposes limitations on train length.

According to a first embodiment of the invention, one of the two redundant DP transceivers in a locomotive is retuned to the HOT/EOT frequency to bidirectionally relay HOT/EOT communications between the HOT device and the EOT device. Messages from one of the HOT or EOT devices are received at the retuned remote DP transceiver, forwarded to the attendant remote DP station and then retransmitted to the other of the HOT or EOT devices via the same retuned DP transceiver.

For example, a retuned DP transceiver in a remote locomotive receives an HOT message from the HOT device (in the lead locomotive) over the HOT/EOT communications channel and forwards the message to the remote DP station. The message is then forwarded to the remote retuned DP transceiver (without changing the message format or protocol) and transmitted to the EOT device over the HOT/EOT communications channel. To the receiving EOT device, the relayed message appears to have been received directly from the HOT device.

As is known by those skilled in the art, the DP transceivers can only receive data or transmit data and are unable to store or retransmit messages. Therefore, the DP transceiver interfaces to an external device, such as the remote DP station, to process (e.g., decode) the messages and handle the retransmission by the receiving DP transceiver. The DP station thus controls the receiving DP transceiver to retransmit the message to the EOT device.

The remote DP transceiver, operating in conjunction with the remote DP station, also receives messages from the EOT device (typically EOT status messages) and retransmits them to the HOT device in the lead locomotive using the HOT/EOT frequency and message format. Messages received at the HOT device are sent to the lead locomotive computer for execution.

After repeating a received HOT or EOT message, the DP transceiver can be turned back to the DP communications frequency if desired. However, since the EOT and HOT devices can transmit messages at anytime, it may be preferable for the redundant DP transceiver to remain tuned to the HOT/EOT communications channel frequency for an extended period. Thus, this embodiment advantageously, and at low cost, utilizes a redundant remote locomotive DP transceiver as a repeater in the HOT/EOT communications channel.

Whether retransmitting/relaying an EOT device message to the HOT device or retransmitting/relaying an HOT device message to the EOT device, the remote DP locomotive transceiver is more likely to successfully transmit the signal to the receiving end, both because the remote DP locomotive is closer to the receiving end and because the DP transceiver operates at a higher output power than either the HOT or the EOT transceivers.

Emergency brake applications (as commanded by the HOT device) and brake pipe problems at the EOT (as reported by the EOT device to the HOT device) are of particular importance; successful transmittal of these messages is vitally important for safe train operation. Periodic status messages from the EOT device (such as the brake pipe pressure at the EOT) may be less time-critical, but can be important for safe and efficient train operation. Using the retuned DP transceiver, operating in conjunction with the remote DP station, as a relay in the HOT/EOT communications channel, this invention drastically improves the probability that the HOT/EOT messages will be successfully received at the receiving end.

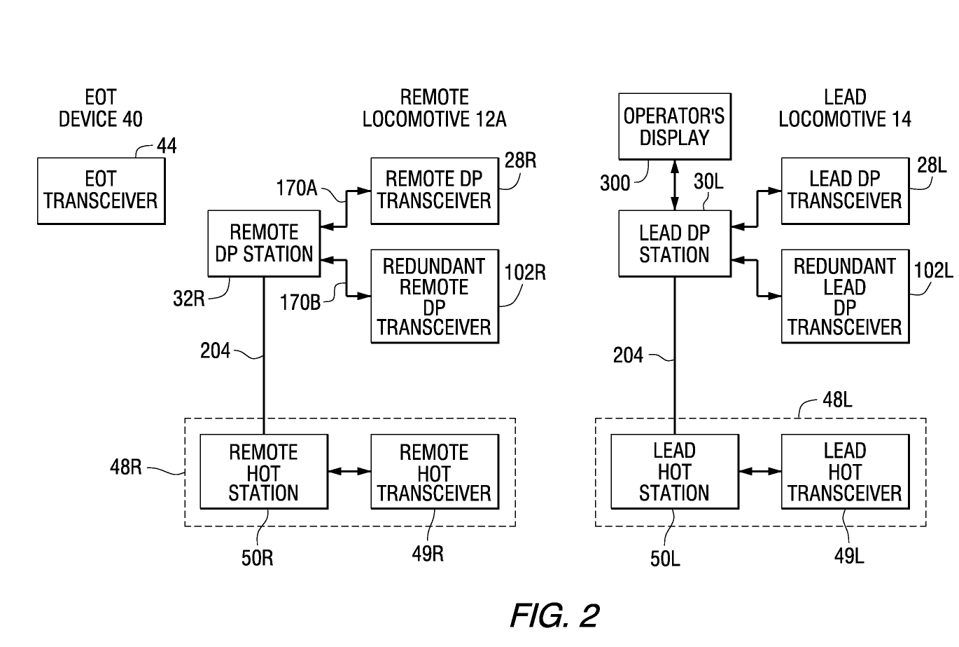

FIG. 2 illustrates certain elements associated with the first embodiment of the present invention. The remote locomotive 12A comprises the remote DP transceiver 28R and a redundant remote DP transceiver 102R, both controlled by the remote DP station 32R. According to the first embodiment, the redundant remote DP transceiver 102R is tuned to the HOT/EOT frequency; the remote DP transceiver 28R continues as an element of the DP network.

The lead locomotive 14 comprises the HOT device 48L (further comprising a lead HOT transceiver 49L and a lead HOT station 50L), the lead DP transceiver 28L, a redundant lead DP transceiver 102L, and the lead DP station 30L. As illustrated, the EOT device 40 includes the EOT transceiver 44.

In the first embodiment, messages from the HOT device 48L are received by the remote DP station 32R from the retuned redundant remote DP transceiver 102R. The messages are processed by the remote DP station 32R and retransmitted from the redundant remote DP transceiver 102R (at a higher power level than received) to the EOT transceiver 44. These messages, which are retransmitted using the same signal protocol and format as received, may comprise an emergency brake application message or a request for EOT status information, for example.

Similarly, EOT messages (transmitted by the EOT transceiver 44) are received by the retuned redundant remote DP transceiver 102R and forwarded to the remote DP station 32R. The messages are returned to the redundant remote DP transceiver 102R and transmitted to the HOT device 48L in the lead locomotive 14.

The operating power of the DP system offers another advantage to using the DP transceivers as repeaters in the HOT/EOT system. The power output of the DP transceivers is about 25-30 W, much higher than the HOT/EOT transceivers that operate at about 2-5 W. This higher output power alone provides better signal performance for the DP transceivers over long distances. Also, DP equipment is available on many operating locomotives, thus minimizing the need for the installation of extra equipment to accommodate longer trains, while providing a functional HOT/EOT system.

While one of the redundant DP transceivers operates as an HOT/EOT repeater, DP functionality is maintained by the second of two DP transceivers aboard the remote locomotives. Although FIG. 2 illustrates only one remote locomotive comprising two redundant DP transceivers, the number of DP transceivers configured to repeater status depends on train length, the number of remote locomotives with DP transceivers, the number of DP transceivers on each remote locomotive, and environmental factors that may degrade the communications link between the EOT and HOT devices.

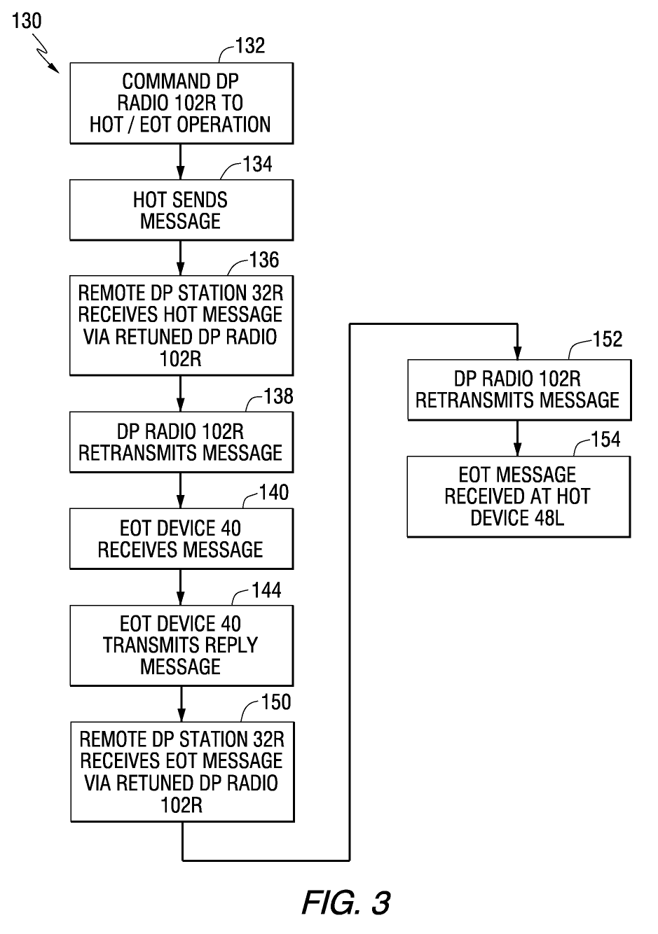

FIG. 3 illustrates a flow chart 130 depicting operation of the elements described above according to the first embodiment of the invention. At a step 132, the operator in the lead locomotive commands the redundant remote DP transceiver 102R to HOT/EOT repeater operation. This can be accomplished by the operator entering a command into the operator's lead DP control console and transmitting the command to the redundant remote DP transceiver 102R. The operator can also manually control the individual DP units and their transceivers. Alternatively, the DP system can automatically retune the redundant remote DP transceiver 102R upon detecting the presence of an HOT/EOT system. When operating as an HOT/EOT repeater, the redundant remote DP transceiver 102R is turned to the frequency assigned to the HOT/EOT communications system for receiving and transmitting the EOT and HOT commands and messages.

At a step 134 the lead HOT transceiver 49L in the lead locomotive 14 transmits an HOT message intended for the EOT device 40. At a step 136 the remote DP station 32R receives the HOT message via the retuned redundant remote DP transceiver 102R. At a step 138 the remote DP station 32R commands the redundant remote DP transceiver 102R to transmit the HOT message on the HOT/EOT signal frequency at a higher power level than the original HOT message. The EOT device 40 receives the message at a step 140. Since the message is unchanged (except as to power level) from the message transmitted from the HOT device 48L, the received message appears to have been sent directly from the HOT device. The EOT device 40 responds by transmitting an EOT reply message at a step 144. Exemplary responses to the HOT message include venting the air brake pipe at the EOT device, and providing a status report, for example regarding the EOT battery charge condition or the brake pipe pressure at the EOT device.

At a step 150 the remote DP station 32R receives the EOT reply message via the retuned redundant remote DP transceiver 102R, boosts the power level, and at a step 152 retransmits the reply message to the HOT device 48L in the lead locomotive 14. At a step 154 the EOT message is received at the HOT device 48L. The EOT message may be displayed on a DP operator's display 300 onboard the lead locomotive 14.

In addition to the EOT reply message processing described above, during operation of the HOT/EOT system, the EOT automatically and periodically sends status messages to the HOT, without prompting from the HOT device. Such status messages are intercepted and repeated by the remote DP station 32R via the retuned redundant remote DP transceiver 102R in its role as an HOT/EOT repeater, as described above for the EOT reply message.

In the embodiment described above one of the two redundant DP transceivers on a remote locomotive serves as an HOT/EOT relay; a second embodiment of the present invention bridges or links the DP communications system and the HOT/EOT communications system. Messages carried on the HOT/EOT system can be advantageously bridged to the DP system, avoiding message duplication in the HOT/EOT and DP systems. Also, bridging HOT/EOT messages to the DP system increases the probability that the HOT/EOT messages will be successfully received. When bridging a message on the HOT/EOT communications channel to the DP communications channel, the message format and protocol can be changed to the DP communications system format and protocol.

According to this embodiment, DP messages carried over the DP communications system are bridged to the HOT/EOT system by a connection between a DP transceiver functioning in the DP system and a DP transceiver retuned to the HOT/EOT frequency. This connection is implemented by the remote DP station 32R or the lead DP station 30L in FIG. 2.

With continued reference to FIG. 2, when remote DP transceiver 28R on the remote locomotive 12A receives, for example, a DP emergency brake application message from the lead DP transceiver 28L in the lead locomotive 14 (the message generated in response to either a lead locomotive-initiated emergency condition or a remote locomotive-initiated emergency condition), or receives an HOT/EOT message embedded within the DP message, the remote DP transceiver 28R communicates this information to the remote DP station 32R over a signal path 170A (e.g., an electrical conductor providing a conductive signal path or an optical channel, either employing a serial or parallel data format). Responsive thereto, the remote DP station 32R communicates the information to the redundant remote DP transceiver 102R (tuned to the HOT/EOT communications channel) over a signal path 170B (e.g., an electrical or conductive signal path or an optical signal path employing a serial or parallel data format). The redundant remote DP transceiver 102R transmits a signal according to the HOT/EOT message format to the EOT transceiver 44 over the HOT/EOT communications channel. In this example, the signal commands opening of the brake pipe at the EOT device. The signal received at the EOT transceiver 44 appears to have originated at the HOT device 48.

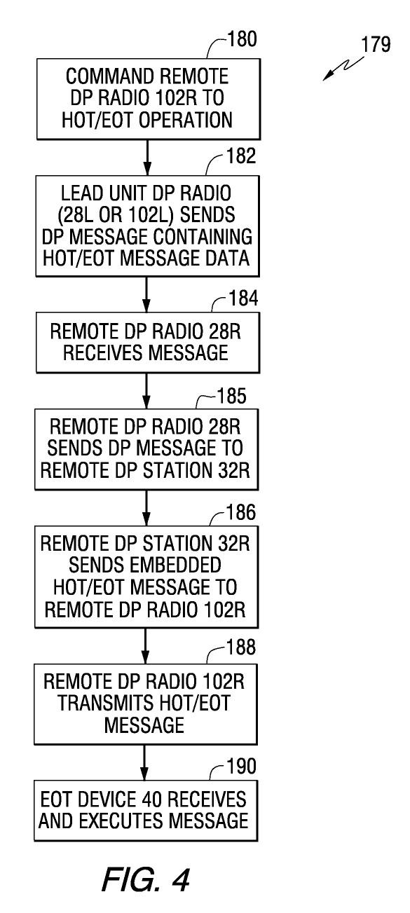

The method of this second embodiment is illustrated in a flowchart 179 of FIG. 4. At a step 180 the redundant remote DP transceiver 102R is commanded to HOT/EOT operation and tuned to the HOT/EOT communications frequency. The remote DP transceiver 28R remains tuned to the DP communications frequency. At a step 182 the operative lead DP transceiver 28L or the redundant lead DP transceiver 102L (both in the lead locomotive 14) sends a DP message (that may contain an HOT/EOT message) intended for the remote DP transceiver 28R. At a step 184 the remote DP transceiver 28R receives the DP message.

At a step 185 the remote DP transceiver 28R sends the DP message to the remote DP station 32R over signal path 170A of FIG. 2. At a step 186 the remote DP station 32R sends a signal (responsive to the received DP message with an HOT/EOT message embedded within the DP message) to the retuned redundant remote DP transceiver 102R over the signal path 170B of FIG. 2. At a step 188 the redundant remote DP transceiver 102R transmits a corresponding HOT/EOT message on the HOT/EOT signal frequency to the EOT device 40. The EOT device 40 receives and executes the message at a step 190.

In an alternative embodiment, when the remote DP station 32R receives the DP message from the remote DP transceiver 28R, the remote DP station 32R sends the message to the remote HOT station 50R of an HOT device 48R, via a link or signal path 204, for transmitting by the remote HOT transceiver 49R to the EOT device 40. See FIG. 2.

Although described above as bridging a DP message to the HOT/EOT communications channel, in another embodiment the DP message may contain an embedded HOT/EOT message intended for the HOT device or the EOT device.

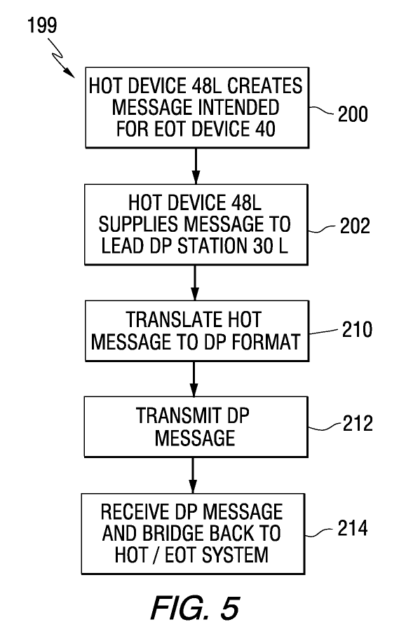

FIG. 5 illustrates a flow chart 199 depicting bridging an HOT message to the DP communications channel, carrying the message over the DP communications channel, and bridging the message back to the HOT/EOT system. At a step 200, the HOT device 48L creates an HOT message intended for the EOT device 40. At a step 202, the HOT device 48L supplies the message to the lead DP station 30L over the signal path 204 illustrated in FIG. 2. The lead DP station 30L translates the HOT message to the DP format, as depicted at a step 210. The lead DP station 30L sends the DP message to the lead DP transceiver 28L (or to the redundant lead DP transceiver 102L) for transmitting over the DP communications system as indicated at a step 212. In another embodiment the step of translating the HOT message to the DP format comprises embedding the HOT message into a DP message format.

The DP message is received at the remote DP transceiver 28R, forwarded to the remote DP station 32R, translated to the HOT/EOT system format, forwarded to the redundant remote DP transceiver 102R, and transmitted from the redundant remote DP transceiver 102R to the EOT device 40. These steps are depicted by a step 214 indicating that the DP message is bridged back to the HOT/EOT system.

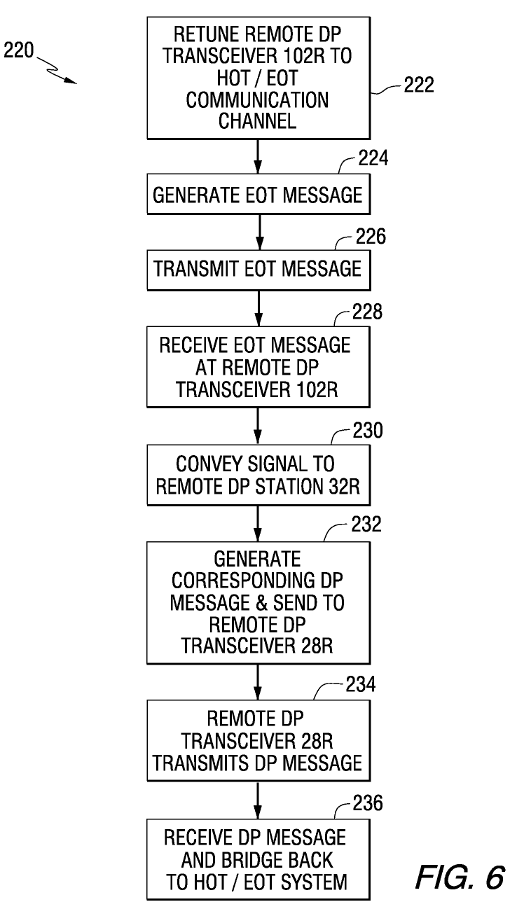

FIG. 6 illustrates a flow chart 220 depicting bridging an EOT message to the DP communications channel, carrying the message along the DP communications channel, and bridging the message back to the HOT/EOT system. At a step 222, the redundant remote DP transceiver 102R is tuned to the HOT/EOT communications channel, while the remote DP transceiver 28R is tuned to the DP communications channel. The EOT device 40 generates an EOT message at a step 224 and transmits the message at a step 226. At a step 228, the redundant remote DP transceiver 102R receives the EOT message on the HOT/EOT communications channel.

At a step 230, the redundant remote DP transceiver 102R conveys a signal, representative of the received message, to the remote DP station 32R over signal path 170B of FIG. 2. At a step 232, the remote DP station 32R generates a corresponding DP message and sends the message to the remote DP transceiver 28R over the signal path 170A. At a step 234 the remote DP transceiver 28R transmits the DP message for receiving by a DP transceiver on another locomotive of the train. In another embodiment the step of generating a corresponding DP message comprises embedding the EOT message into a DP message.

The DP message (which represents the original EOT message) is received, for example, at the lead DP transceiver 28L, forwarded to the lead DP station 30L, translated to the HOT/EOT system format, and forwarded to the HOT station 50L for execution. These processes are depicted by a step 236, indicating that the message is bridged back to the HOT/EOT system.

In another embodiment not illustrated, the DP message transmitted from the remote DP transceiver 28R can “leap frog” to the head end of the train by receiving and retransmitting the DP signal at each remote locomotive disposed between the head end of the train and the remote locomotive 12A.

According to another embodiment of the invention, each remote locomotive is equipped with a separate dedicated HOT transceiver (in addition to the DP transceivers) to transmit/receive the HOT/EOT messages without jeopardizing the operation or the redundancy of the DP communications system. In this embodiment it is not necessary to retune one of the redundant DP transceivers to an HOT/EOT channel frequency, bridge the HOT/EOT message to the DP system, transmit the message over the DP communications system, and bridge the message back to the HOT/EOT system.

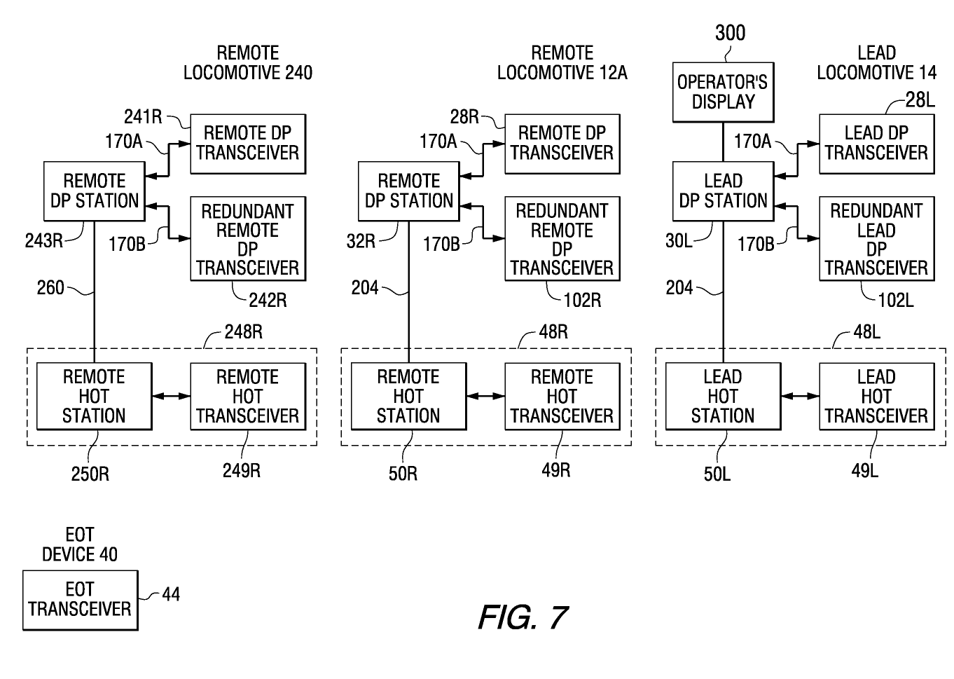

This embodiment, illustrated in FIG. 7, includes the remote locomotive 12A and another remote locomotive 240. The latter locomotive is separated from both the remote locomotive consist of remote locomotive 12A and the trailing remote locomotive 12B and the EOT device 40 by railcars (not shown in FIG. 7). The trailing remote locomotive 12B illustrated in FIG. 2 is not shown in FIG. 7 and according to the invention may or may not be present. The remote locomotive 240 comprises a remote DP transceiver 241R and a redundant remote DP transceiver 242R, a remote DP station 243R, and a remote HOT device 248R, which further comprises a remote HOT transceiver 249R and a remote HOT station 250R. The remote DP station 243R communicates with the remote HOT device 248R over a signal path 260 (e.g., a serial or parallel signal paths), comprising a conductive connection or an optical connection or the like.

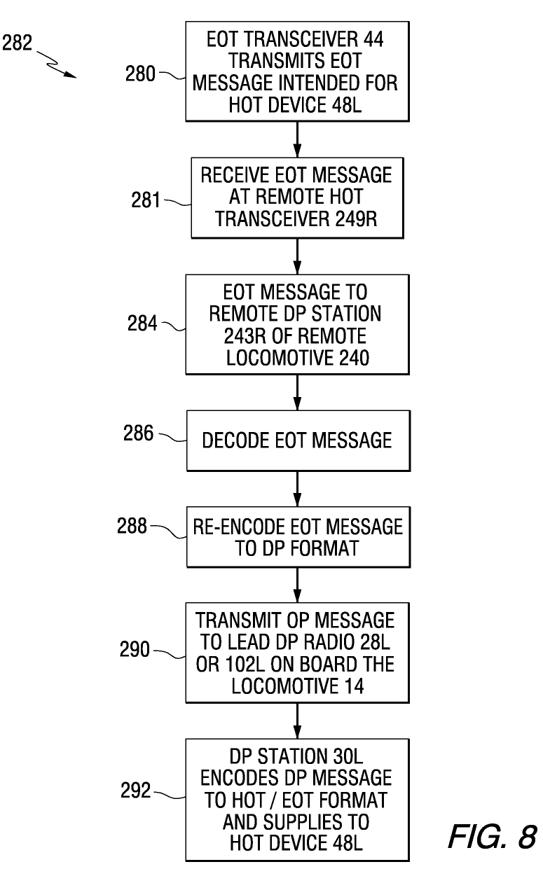

The EOT transceiver 44 transmits an EOT message intended for the HOT device 48L on the lead locomotive 14 using conventional HOT/EOT protocol, message formats, frequencies, etc. The remote HOT transceiver 249R on the remote locomotive 240 receives the EOT message. See steps 280 and 281 of a flowchart 282 of FIG. 8. The EOT message is passed from the remote HOT transceiver 249R to the remote HOT station 250R, to the remote DP station 243R over the signal path 260. See a step 284 of the flowchart 282 and the FIG. 7 block diagram.

At a step 286, the remote DP station 243R decodes the received EOT message and re-encodes (at a step 288) the message information into standard DP message format. The remote DP station 243R onboard the remote locomotive 240 supplies the DP message to either the remote DP transceiver 241R or the redundant remote DP transceiver 242R for transmission to an operative one of the lead DP transceiver 28L and the redundant lead DP transceiver 104L over the DP communications system. See a step 290 of the flowchart 282. The present invention, in its various embodiments, is intended to include operation of the DP system with any number of remote locomotives in the DP communications chain.

In another embodiment the step of re-encoding the EOT message into the DP message format comprises embedding the EOT message into the DP message.

From the receiving lead DP transceiver 28L or the redundant lead DP transceiver 102L the message is supplied to the lead DP station 30L where the message is converted to the HOT/EOT format and supplied to the HOT device 48L in the lead locomotive 14 over the signal path 204. See a step 292 of the flowchart 282. Thus, according to this embodiment the DP communications system provides a link between the EOT device 40 and the HOT device 48L in the lead locomotive 14.

For HOT messages intended for the EOT device, the system described above functions similarly but in an opposite direction. HOT messages generated in the HOT device 48L of the lead locomotive 14 are passed to the lead DP station 30L via the signal path 204. The lead DP station encodes the message into the conventional DP format, protocol, frequency, etc. and transmits the message over the DP communications channel via one of the lead DP transceiver 28L and the redundant lead DP transceiver 102L. The operative remote DP transceiver 28R or the redundant remote DP transceiver 102R in the remote locomotive 12A receives the DP message and forwards it to the remote DP station 32R where it is converted to the HOT/EOT message format. The converted message is sent to the HOT device 48R in the remote locomotive 12A. The HOT device 48R transmits the HOT message to the EOT device 40. The EOT device 40 receives the message as if the message had been transmitted from the HOT device 48L in the lead locomotive 14.

As an alternative to the embodiment described immediately above, instead of the remote DP station 32R converting the message to the HOT/EOT format and supplying the message to the HOT device 48R, the remote DP station 32R retransmits the received DP message over the DP communications channel for receiving at the remote locomotive 240. Upon receipt by one of the remote DP transceiver 241R and the redundant remote DP transceiver 242R, the remote DP station 243R converts the message to the HOT/EOT message format and sends the message to the remote HOT device 248R in the remote locomotive 240. The remote HOT device 248R then transmits the EOT message to the EOT device 40.

When employed on a railroad train, typically the HOT message is converted to the DP format at the lead locomotive and sent along the train over the DP communications system. The last remote locomotive decodes the message to the HOT/EOT format and supplies the HOT message to the remote HOT device on the last remote locomotive for sending to the EOT device.

In an alternative embodiment, each of the remote locomotives converts the DP message (that represents an HOT message) to HOT/EOT format and supplies the message to the HOT device on the remote locomotive. Each of the HOT devices transmits the message for receiving by the EOT device. Employing the HOT device on each remote locomotive to transmit the HOT message may increase the probability of the HOT message reaching the EOT device.

Similarly, EOT messages are received by the HOT device on the last locomotive, transferred to the DP systems, and communicated over the DP system to the DP transceiver on the lead locomotive. Upon receipt at the lead locomotive, the HOT message is converted back to the HOT/EOT format and supplied to the HOT device on the lead locomotive.

As a refinement to the embodiment of FIGS. 7 and 8, in the lead locomotive 14, in addition to supplying the EOT status information received over the DP system to the HOT device 48, the information is routed to the DP operator's display 300 shown in FIG. 7. The information is displayed at the DP operator's display 300 using the same format as the DP information. Thus the EOT essentially becomes the last “remote locomotive” on the operator's display.

Another embodiment pertains to EOT devices that include functionality to make service brake applications. According to the conventional DP system, when a lead locomotive operator makes a service brake application in the lead locomotive, the DP system commands a service brake application at the remote locomotives 12A and 240 of FIG. 7.

According to this embodiment and with reference to the system of FIG. 7, the brake application command is sent from the remote DP station 243R in the remote locomotive 240 to the remote HOT device 248R in the same locomotive over the signal path 260.

The remote HOT device 248R encodes the brake application command into the conventional HOT/EOT signal format and transmits the signal to the EOT device 40. The EOT device 40, when making a service brake application, functions as the “last remote locomotive” in the train. Any of the techniques described herein can be employed to communicate the service brake application command to the EOT device.

In the various embodiments described herein, the step of re-encoding the HOT message into the DP message format comprises embedding the HOT message into the DP message.

Another embodiment pertains to HOT/EOT devices that operate on the same transceiver frequency as the DP system. Although the HOT/EOT devices and the DP devices utilize different data protocols and message formats, use of the same frequency may cause the signals to interfere with each other and degrade performance of both systems. Thus, according to this embodiment, the message format of the HOT/EOT devices is modified to add DP header data bits (a single byte for example) and DP footer bits. These modifications to the HOT/EOT message format allow the DP system to recognize the HOT/EOT messages as valid messages and not as interfering messages. The DP stations on the lead and remote locomotives continue to use conventional DP message formats.

Further, the lead and remote locomotives can decode and execute the reformatted HOT/EOT messages as valid DP messages to the extent that any such messages command execution of certain defined functions such as emergency brake applications at the receiving remote locomotive. Upon receipt of the modified HOT/EOT message at the last remote in the train, the DP system recognizes the message as intended from the EOT device and transmits the message to the EOT device according to any of the embodiments described herein. The EOT device receives the modified HOT/EOT message, ignores the header and footer bits, and executes the message according to the HOT/EOT message.

According to certain embodiments of the present invention, EOT status information from the EOT device is received at the last DP remote locomotive and transmitted to the DP system in the lead locomotive using conventional DP messaging. During the DP linking process, the linking message from the last DP remote locomotive includes information indicating its communications link to the EOT device. The lead locomotives receiving a DP message from the last locomotive must be able to determine whether the message originated from the last locomotive or from the EOT device. This is accomplished by including an identifier in the DP message indicating that the message originated from the EOT device or contains EOT status information.

The last remote locomotive gathers the EOT status information and creates a remote DP status message, including both the remote locomotive status information and the EOT status information. Upon receipt at the lead locomotive, the remote DP status information is processed as any other remote DP message.

The EOT status information, embedded in the status information from the last DP locomotive, can be displayed on the DP operator's display 300 and/or passed to the HOT device 48 in the lead locomotive. The identifier in the DP message generates a display indication that the message originated with the EOT device.

As a further embodiment, the HOT/EOT message format is modified to the DP message format and protocol. The EOT device 40 then serves as the last remote locomotive of the train. DP messages intended for the EOT device 40 are prepared according to the DP message format and messages from the EOT device 40 are similarly prepared. A message received from the last locomotive in the train, which in fact is the EOT device, can be displayed on the operator's DP display and/or sent to the HOT device 48 in the lead locomotive for processing and display. If equipped with brake application functionality, DP system messages received at the EOT device can command brake applications at the EOT device 40.

Typically, an interface device is disposed between the HOT device 48L and the locomotive computer/display (not shown in the figures). According to certain embodiments of the invention as described above, HOT/EOT messages are carried over the DP system. In such embodiments the HOT station 50L (see FIGS. 2 and 7) may not be present and an interface to the DP system is provided instead. Thus according to these embodiments the DP system provides the functionality of the HOT station 50L.

Although the features of the present invention have been described by reference to one or two remote DP locomotives, those skilled in the art recognize that the concepts are extendable to more than two remote DP locomotives, each operating as a repeater in a serial string of repeaters in the HOT/EOT communications path.

Throughout the description of the present invention, the terms “radio link”, “RF link,” and “RF communications” and similar terms describe a method of communicating between two links in a network. It should be understood that the communications link between nodes (e.g., locomotives) in the system in accordance with the present invention is not limited to radio or RF systems or the like and is intended to cover all techniques by which messages may be delivered from one node to another or to plural others, including without limitation, magnetic systems, acoustic systems and optical systems. Likewise, the system of the present invention is described in connection with an embodiment in which radio (RF) links are used between nodes and in which the various components are compatible with such links; however, this description of the presently preferred embodiment is not intended to limit the invention to that particular embodiment.

While the invention has been described with reference to various embodiments thereof, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for communicating messages between an HOT device in a lead locomotive and an EOT device at an end-of-train position of a railroad train, the railroad train further comprising a remote locomotive between the lead locomotive and the EOT device, the method comprising:
tuning a DP transceiver onboard the remote locomotive to a frequency of an HOT/EOT communications channel;
transmitting a message from the EOT device intended for the HOT device or a message from the HOT device intended for the EOT device;
receiving the message at the DP transceiver;
if the message was transmitted from the EOT device:
transmitting the message from the DP transceiver to the HOT device; and
receiving and executing the message at the HOT device; and
if the message was transmitted from the HOT device:
transmitting the message from the DP transceiver to the EOT device; and
receiving and executing the message at the EOT device.

2. The method of claim 1 wherein the remote locomotive further comprises a remote DP station, and wherein the steps of transmitting the message from the DP transceiver to the HOT device and transmitting the message from the DP transceiver to the EOT device each further comprise forwarding the message to the remote DP station, returning the message to the DP transceiver, and retransmitting the message from the DP transceiver.

3. The method of claim 1 wherein the message from the EOT device comprises one or more of a brake pipe pressure at the end-of-train position, a condition of a battery at the end-of-train position, a condition of a warning light at the end-of-train position, an end-of-train status message, or an emergency condition at the end-of-train position.

4. The method of claim 1 wherein the message from the HOT device comprises a request for a status of the EOT device, a service brake application command for an air valve in a brake pipe at the end-of-train position, or an emergency brake application command for the air valve at the end-of-train position.

5. The method of claim 1 wherein an output power of the HOT device and an output power of the EOT device is between 2 and 5 W and an output power of the DP transceiver is between 25 and 30 W.

6. The method of claim 1 wherein the message comprises a message from the EOT device and the method further comprises displaying the message on a DP display in the lead locomotive.

7. The method of claim 1 further comprising tuning the DP transceiver to a frequency of a DP communications channel after the step of transmitting the message from the DP transceiver to the HOT device or after the step of transmitting the message from the DP transceiver to the EOT device.

8. The method if claim 1 wherein a message format of the message comprises an HOT/EOT message format.

9. A method for communicating messages between an HOT device comprising an HOT transceiver and an EOT device comprising an EOT transceiver, the HOT device at a head-end position of a railroad train and the EOT device at an end-of-train position of the railroad train, the railroad train further comprising a remote locomotive between the head-end position and the end-of-train position, the method comprising:
tuning a first DP transceiver on the remote locomotive to a frequency of a DP communications channel;
tuning a second DP transceiver on the remote locomotive to a frequency of an HOT/EOT communications channel;
receiving at the first DP transceiver a DP message on the DP communications channel;
from the first DP transceiver, inputting a signal to the second DP transceiver, the signal responsive to the DP message; and
from the second DP transceiver, sending an HOT/EOT message over the HOT/EOT communications channel, the HOT/EOT message responsive to the signal.

10. The method of claim 9 further comprising receiving the HOT/EOT message by the HOT transceiver and executing the message by the HOT device or receiving the HOT/EOT message by the EOT transceiver and executing the message by the EOT device.

11. The method of claim 9 wherein a format of the HOT/EOT message comprises an HOT/EOT message format.

12. The method if claim 9 wherein the DP message comprises a service brake application command or an emergency brake application command.

13. The method of claim 9 wherein the step of inputting the signal to the second DP transceiver comprises inputting the signal to a remote DP station onboard the remote locomotive, the remote DP station inputting the signal to the second DP transceiver.

14. The method of claim 9 wherein the DP message comprises an HOT/EOT message embedded within the DP message.

15. A method for transferring an HOT message to a DP communications channel of a railroad train, the method comprising:
tuning a lead locomotive DP transceiver to a frequency of a DP communications channel;
generating the HOT message at an HOT device in the lead locomotive;
sending the HOT message to the lead locomotive DP transceiver;
from the lead locomotive DP transceiver, transmitting a DP message, the DP message responsive to the HOT message; and
receiving the DP message at a DP transceiver onboard a remote locomotive of the railroad train.

16. The method of claim 15 wherein the step of generating the HOT message comprises generating the HOT message responsive to a service brake or an emergency brake application.

17. The method of claim 15 wherein the step of sending the DP message further comprises translating the HOT message to a format of the DP message prior to sending the DP message or embedding the HOT message in the DP message prior to sending the DP message.

18. The method of claim 15 further comprising a step of bridging the DP message back to an HOT/EOT communications system onboard the remote locomotive.

19. A method for transferring an EOT message to a DP communications channel of a railroad train, the method comprising:
tuning a first DP transceiver onboard a remote locomotive of the railroad train to a frequency of a DP communications channel;
tuning a second DP transceiver onboard the remote locomotive to a frequency of an HOT/EOT communications channel;
generating the EOT message at an EOT device;
transmitting the EOT message from the EOT device;
receiving the EOT message at the second DP transceiver;
generating a DP message responsive to the EOT message;
conveying the DP message to the first DP transceiver; and
transmitting the DP message from the first DP transceiver.

20. The method of claim 19 wherein the step of generating the DP message further comprises supplying the EOT message to a DP station onboard the remote locomotive, the DP station for generating the DP message responsive to the EOT message.

21. The method of claim 20 wherein the step of generating the DP message responsive to the EOT message further comprises translating the EOT message to a format of the DP message or embedding the EOT message in the DP message.

22. The method of claim 19 further comprising receiving the DP message transmitted from the first DP transceiver at a second DP transceiver onboard a lead locomotive of the railroad train, generating an HOT/EOT message responsive to the DP message, and conveying the HOT/EOT message to an HOT device onboard the lead locomotive.

23. A method for communicating HOT/EOT messages between an HOT transceiver onboard a lead locomotive and an EOT transceiver at an end-of-train position of a railroad train, and for communicating DP messages between a lead locomotive at a head end of the train and a remote locomotive, the method comprising:
tuning a DP transceiver onboard the lead locomotive and a DP transceiver onboard the remote locomotive to a frequency of a DP communications channel;
tuning an HOT transceiver onboard the remote locomotive to a frequency of an HOT/EOT communications channel;
sending and receiving DP messages on the DP communications channel at the DP transceiver onboard the lead locomotive and the DP transceiver onboard the remote locomotive; and
sending and receiving HOT/EOT messages on the HOT/EOT communications channel by operating the HOT transceiver onboard the remote locomotive as a relay between the HOT transceiver onboard the lead locomotive and the EOT transceiver at the end-of-train position.

24. A method for communicating HOT/EOT messages between an HOT device and an EOT device of a railroad train, the railroad train further comprising a lead locomotive and a remote locomotive, the method comprising:
generating a first EOT message at the EOT device;
transmitting the first EOT message;
receiving the first EOT message at an HOT transceiver onboard the remote locomotive;
communicating a signal responsive to the first EOT message from the HOT transceiver onboard the remote locomotive to a DP transceiver onboard the remote locomotive;
the DP transceiver onboard the remote locomotive transmitting a DP message to a DP transceiver onboard the lead locomotive, the DP message responsive to the first EOT message;
the DP transceiver onboard the lead locomotive receiving the DP message;
the DP transceiver onboard the lead locomotive generating a second EOT message responsive to the DP message; and
communicating the second EOT message to an HOT transceiver onboard the lead locomotive.

25. The method of claim 24 further comprising displaying the second EOT message on a display onboard the lead locomotive.

26. The method of claim 24 wherein the DP message responsive to the first EOT message comprises the first EOT message embedded in the DP message.

27. A method for communicating an HOT message from an HOT device onboard a lead locomotive to an EOT device of a railroad train, the railroad train further comprising a lead locomotive and a remote locomotive, the method comprising:
generating a first HOT message at the HOT device;
conveying the first HOT message to a DP transceiver onboard the lead locomotive;
converting the first HOT message to a DP message;
transmitting the DP message from the DP transceiver onboard the lead locomotive;
receiving the DP message at a DP transceiver onboard the remote locomotive;
converting the DP message to a second HOT message at the remote locomotive;
conveying the second HOT message to an HOT transceiver onboard the remote locomotive;
transmitting the second HOT message from the HOT transceiver onboard the remote locomotive; and
receiving the second HOT message by the EOT device.

28. The method of claim 27 wherein the step of converting the first HOT message to a DP message is executed at a DP station onboard the lead locomotive and the step of converting the DP message to the second HOT message is executed at a DP station onboard the remote locomotive.

29. The method of claim 27 wherein the step of converting the first HOT message to the DP message comprises embedding the first HOT message into the DP message.

30. A method for communicating HOT/EOT messages over an HOT/EOT communications channel of a railroad train, and for communicating DP messages over a DP communications channel of the railroad train, the method comprising:
generating DP messages according to a DP message format;
generating HOT/EOT messages according to an HOT/EOT message format with a DP header;
receiving the DP messages at a DP transceiver, the DP messages carried by a signal at a first frequency; and
receiving the HOT/EOT messages at a DP transceiver or receiving the HOT/EOT messages at an EOT device, the HOT/EOT messages carried by a signal at the first frequency.

31. The method of claim 30 wherein the HOT/EOT messages comprise an EOT status message and wherein the DP transceiver receiving the HOT/EOT messages is disposed in a lead locomotive of the railroad train.

32. The method of claim 30 wherein the HOT/EOT messages comprise an HOT message intended for the EOT device.

33. The method of claim 30 wherein the step of receiving the HOT/EOT messages at a DP transceiver further comprises decoding the HOT/EOT message and executing the HOT/EOT message.

34. A method for communicating HOT/EOT messages and for communicating DP messages along a railroad train, the HOT/EOT messages and the DP messages transmitted on the same frequency, the method comprising:
generating the DP messages according to a DP message format;
generating the HOT/EOT messages according to the DP message format;
receiving DP and HOT/EOT messages at a DP transceiver;
executing the DP messages at a remote locomotive of the railroad train or at the lead locomotive; and
executing the HOT/EOT messages at an HOT device onboard the remote or the lead locomotive or executing the HOT/EOT messages at an EOT device at an end of the railroad train.

35. An apparatus for communicating messages between an HOT/EOT communications system and a DP communications system of a railroad train, the apparatus comprising:
a first DP transceiver onboard a locomotive of the railroad train, the first DP transceiver tuned to a frequency of a DP communications channel;
a second DP transceiver onboard the locomotive tuned to a frequency of an HOT/EOT communications channel; and
a signal path between the first and the second DP transceivers, wherein responsive to a first DP message received by the first DP transceiver a first signal is carried to the second DP transceiver over the signal path, and responsive to a first HOT/EOT message received by the second DP transceiver a second signal is carried to the first DP transceiver over the signal path;
wherein the first DP transceiver transmits a second DP message over the DP communications channel, the second DP message responsive to the second signal; and
wherein the second DP transceiver transmits a second HOT/EOT message over the HOT/EOT communications channel, the second HOT/EOT message responsive to the first signal.

36. The apparatus of claim 35 wherein the signal path comprises an optical signal path or a conductive signal path.

37. The apparatus of claim 35 wherein the second DP transceiver is onboard a lead locomotive of the railroad train and is connected to an HOT device onboard the lead locomotive, and wherein the first HOT/EOT message comprises an HOT message, and wherein the second DP transceiver transmits the HOT message over the HOT/EOT communications channel responsive to the HOT device.

38. The apparatus of claim 35 wherein the first HOT/EOT message comprises a service brake application command or an emergency brake application command.

39. An apparatus for communicating DP messages and HOT/EOT messages on a railroad train, the apparatus comprising:
a first and a second transceiver on a remote locomotive tuned to a frequency of a DP communications channel for communicating DP messages; and
a third transceiver on the remote locomotive tuned to a frequency of an HOT/EOT communications channel for communicating HOT/EOT messages.
